(19) United States
(12) Patent Application Publication
(10) Pub. No.: US 2011/0296096 A1
(43) Pub. Date: Dec. 1, 2011

(54) Method And Apparatus For Virtualized Microcode Sequencing

(76) Inventors: Xiang Zou, Portland, OR (US); Per Hammarlund, Hillsboro, OR (US); Ronak Singhal, Hillsboro, OR (US); Hong Wang, Fremont, CA (US)

(21) Appl. No.: 12/912,169

(22) Filed: Oct. 26, 2010

Related U.S. Application Data
(60) Provisional application No. 61/349,629, filed on May 28, 2010.

(51) Int. Cl. G06F 12/06; G06F 12/08

(52) U.S. Cl. 711/105; 711/125; 711/E12.02; 711/E12.078

(57) ABSTRACT

In one embodiment, the present invention includes a processor having multiple cores and an uncore. The uncore may include a microcode read only memory to store microcode to be executed in the cores (that themselves do not include such memory). The cores can include a microcode sequencer to sequence a plurality of micro-instructions (uops) of microcode that corresponds to a macro-instruction to be executed in an execution unit of the corresponding core. Other embodiments are described and claimed.

This application claims priority to U.S. Provisional Patent Application No. 61/349,629 filed on May 28, 2010, entitled METHOD AND APPARATUS FOR VIRTUALIZED MICROCODE SEQUENCING.

### BACKGROUND

### Background

In modern processors, so-called user-level instructions, namely instructions of an instruction set architecture (ISA), are in the form of macro-instructions. These instructions as implemented in software are not directly executed by processor hardware due to the complexity of the instruction set. Instead, each macro-instruction is typically translated into a series of one or more micro-operations (uops). It is these uops that are directly executed by the hardware. The one or more micro-operations corresponding to a macro-instruction is referred to as a microcode flow for that macro-instruction. The combined execution of all the flow's uops produces the overall results (e.g., as reflected in registers, memory, etc.) specified for that instruction architecturally. The translation of a macro-instruction into one or more uops is associated with the instruction fetch and decode portion of a processor's overall pipeline.

In modern out-of-order processors, the microcode that includes the uops of the microcode flows is stored in a read only memory (ROM) of the processor, referred to as a uROM. Reading of microcode out of uROM is tied to a microcode sequencer (MS) pipeline of the processor. While the location of this ROM within the processor provides for minimal latency in accessing uops therefrom, its read only nature prevents updates to the microcode and further places a practical limit on the size of the available microcode.

### BRIEF DESCRIPTION OF THE DRAWINGS

FIG. 1 is a high level block diagram of a processor in accordance with an embodiment of the present invention.

FIG. 2 is a block diagram of a front end unit of a processor in accordance with an embodiment of the present invention.

FIG. 3 is a block diagram of a processor pipeline in accordance with one embodiment of the present invention.

FIG. 4 is a block diagram of a state machine in accordance with one embodiment of the present invention.

FIG. 5 is a block diagram of a state machine in accordance with another embodiment of the present invention.

FIG. 6 is a flow diagram of a method for performing microcode sequencing operations in accordance with one embodiment of the present invention.

FIG. 7 is a block diagram of a system in accordance with an embodiment of the present invention.

FIG. 8 is a block diagram of interaction between next micro-instruction generation logic and various components of an instruction fetch unit in accordance with one embodiment of the present invention.

### DETAILED DESCRIPTION

In various embodiments, microcode may be stored in architecturally addressable storage space (such as system memory, e.g., a dynamic random access memory (DRAM)), within and/or outside of a processor. The exact location of such storage can vary in different implementations, but in general may be anywhere within a memory system, e.g., from cache storage within the processor to mass memory of a system. A virtualized microcode sequencer (MS) mechanism may be used to fetch and sequence microcode stored in this architecturally addressable space.

In modern processors, generally speaking, the MS holds all complex microcode flows in microcode read only memory (uROM) and random access memory (uRAM) (which stores patch microcode) and is responsible for sequencing and participating in executing these microcode flows. By performing microcode sequencer virtualization in accordance with an embodiment of the present invention, “microcode” can be stored in any architecturally addressable memory space. The term “microcode” as used herein thus refers both to microcode flows conventionally stored in MS uROM and uRAM, traditionally referred as the microcode, and microcode flows in accordance with an embodiment of the present invention stored there or elsewhere and which can be generated in some implementations through other means, such as binary translation, static compilation, or manually written (e.g., to emulate or implement new instructions or capabilities on an existing implementation), etc. Such microcode flows may use the same microcode instruction set that is used to implement those stored in uROM. However, they may be stored in different places in the architecturally addressable memory hierarchy. A virtualized microcode sequencer enables the MS of a processor to fetch and sequence both existing uROM microcode as well as new microcode flows stored elsewhere. The virtualized microcode sequencer leverages an instruction fetch unit (IFU) of the processor to fetch “microcode” stored in the architecturally addressable space into the machine and to cache them into an instruction cache, and may have different designs in different implementations.

In some embodiments, a conventional uROM may be completely removed from the MS and the image stored in this uROM may instead be placed in an architecturally addressable memory space. The location of this space can vary, and may be present in another storage of a processor or outside of a processor, either in a system memory, mass storage, or other addressable storage device. In this way, a virtualized microcode sequencer mechanism can support a full micro-instruction set that is complete in functionality. In other implementations, it is possible to implement a hybrid arrangement such that additional microcode (apart from a uROM and potentially a uRAM) can be stored in another part of a memory hierarchy.

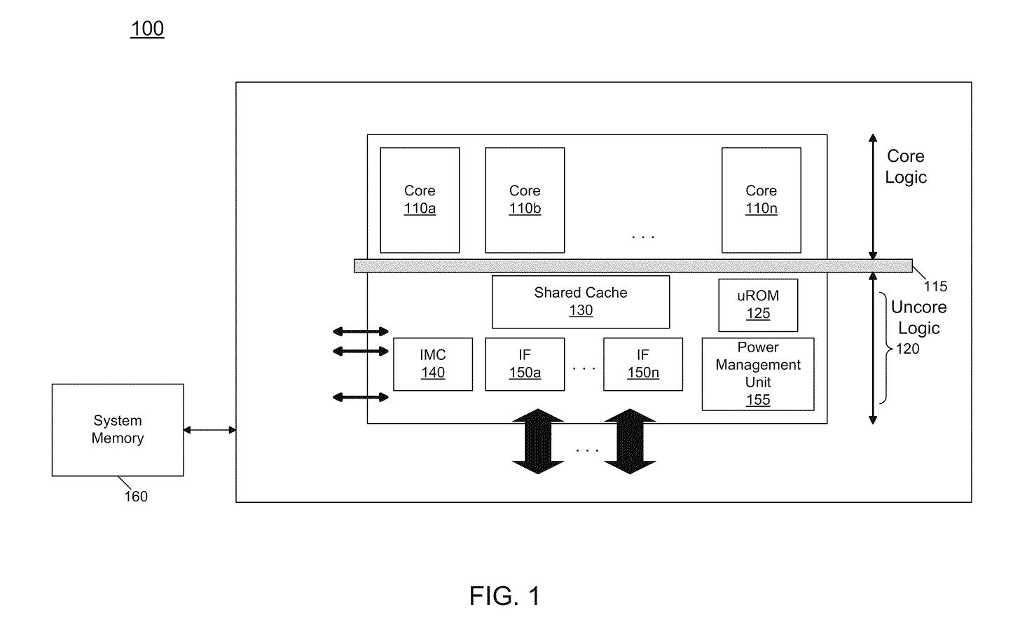

Referring now to FIG. 1, shown is a high level block diagram of a processor in accordance with an embodiment of the present invention. As shown in FIG. 1, processor 100 may be a multicore processor including a plurality of cores 110ₐ-110ₙ. The various cores may be coupled via an interconnect 115 to an uncore 120 which is logic of the processor outside of the core that includes various components. As seen, the uncore 120 may include a microcode uROM 125 that may store microcode to be used by the various cores. This uROM may be architecturally addressable so that microcode sequencers within the cores can initiate access to uROM 125. In addition, uncore 120 may include a shared cache 130 which may be a last level cache. In addition, the uncore may include an integrated memory controller 140, various interfaces 150 and a power management unit 155. As seen, processor 100 may communicate with a system memory 160, e.g., via a memory bus. In addition, by interfaces 150, connection can be made to various off-chip components such as peripheral devices, mass storage and so forth. While shown with this particular implementation in the embodiment of FIG. 1, the scope of the present invention is not limited in this regard.

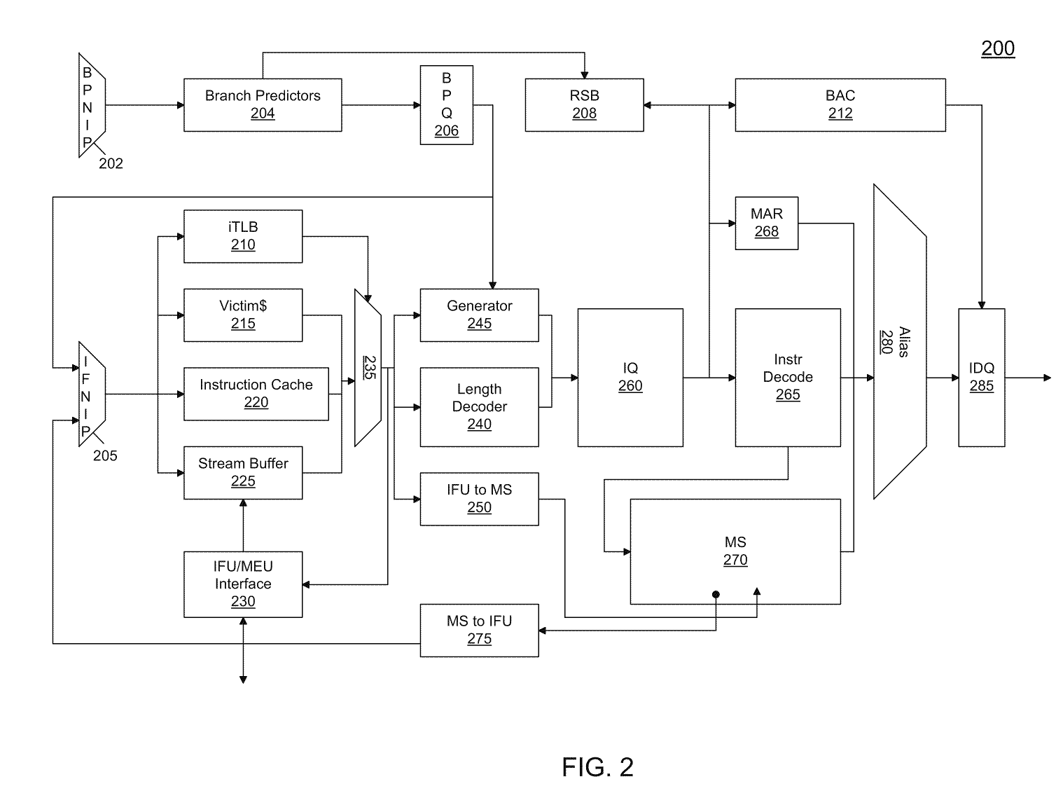

Referring now to FIG. 2, shown is a block diagram of a front end unit of a processor in accordance with an embodiment of the present invention. As seen in FIG. 2, front end unit 200 includes various components of a pipeline. With reference to microcode operations enabled by an embodiment of the present invention, focus herein will be on elements of the instruction fetch pipeline and microcode sequencer pipeline that are used in obtaining microcode from wherever it is stored within a system.

As seen in FIG. 2, an instruction fetch unit (IFU) 200 may include a front end selector 205 to select an incoming address coming, e.g., from branch prediction logic or from a microcode sequencer-to-IFU interface 275, details of which will be discussed further below. The selected address is provided to various front end storage structures including an instruction translation lookaside buffer (TLB) (iTLB) 210, a victim cache 215, and an instruction cache 220, which may be a shared cache that can store both macro-instructions and uops. Still further, the selector may provide the selected instruction pointer to a streaming buffer 225. In turn, these various storage structures may be coupled to another selector 235 which may provide a selected output to a steering generator 245, a length decoder 240 and an IFU-to-MS data interface 250.

An instruction queue 260 may store incoming instruction bytes prior to their being decoded in an instruction decoder 265. The instruction decoder is further coupled to a microcode sequencer 270. Note that in various embodiments, this microcode sequencer may not include any uROM, in contrast to a conventional microcode sequencer. However, in a hybrid implementation, at least some amount of microcode can be stored in a uROM of microcode sequencer 270, as will be discussed further below. The outputs of the microcode sequencer 270 and instruction decoder 265 and a macro alias register (MAR) 268 may be provided to a backend selector 280, which resolves aliases and provides the selected instructions to decoded instruction queue 285. In turn, instructions corresponding to decoded uops may be passed to further portions of a processor pipeline. For example, from this front end unit, decoded instructions may be provided to processing logic of processor. In yet other implementations, the decoded instructions may be provided to an out-of-order unit, to issue uops to execution units out of program order.

As further shown in FIG. 2, the instruction fetch unit may further include a branch prediction pipeline, including a front end selector 202, one or more branch predictors 204, and a branch prediction queue 206. A seen, predicted branches may further be coupled to return stack buffer (RSB) 208, which in turn is coupled to various components, including a branch target address calculator (BAC) 212.

As seen in FIG. 2, the input to instruction pointer selector 205 may be a linear instruction pointer (LIP), which is either the target of a previously executed branch or a prediction from a previous fetch location or reissue of a previous fetch. The IFU uses the LIP to initiate a page translation in iTLB 210 and a lookup in instruction cache 220. Assuming a hit in both iTLB and the instruction cache, a number of instruction bytes (e.g., 16) may be provided to instruction length decoder 240. This decoder may sort the raw bytes from memory into groups that make complete instructions. Instruction prefixes and other instruction attributes are also processed at this time. The resulting sorted and aligned instructions can be written to instruction queue (IQ) 260.

Macro-instructions are read out of IQ 260 and then are decoded into uops by decoders in instruction decoder (ID) 265. ID 265 provides uops for simple macro-instructions whose microcode flows require no more than a predetermined minimal number of uops (e.g., 4). Instead, microcode sequencer (MS) 270 sequences uops for complex macro-instructions whose microcode flows require more than the predetermined minimal number of uops. Uops produced by both ID 265 and MS 270 may be written into instruction decode queue (IDQ) 285 where they are read out and sent to subsequent pipeline stages.

To enable accessing microcode from wherever it may be stored in a hierarchy of an addressable memory subsystem, the MS is invoked when a complex instruction is encountered. Given that in various embodiments, some or all of the uROM is removed from MS 270 and the uROM image resides in the memory space, a request engine of the MS may convert a uROM read into an IFU fetch request. That is, each complete transaction has a predefined entry point in the uROM. This is used when the decoder detects a CISC instruction. After that a MS jump execution unit (JEU) and UIF recycle logic provide the source of the next uop, as described further below. As seen in FIG. 2, these MS fetch requests may be injected into the IFU pipeline as a next instruction pointer, via interface 275, to perform a lookup in instruction cache 220 and streaming buffer 225 after the execution pipeline is drained.

Note that in various embodiments, the instruction cache lookup for a MS microcode fetch request is the same as that for a macro-instruction code fetch request. If the lookup hits instruction cache 220, the data read out of the cache is considered as valid and is forwarded to the subsequent pipeline stages. If instead the lookup misses the cache, the IFU may become responsible for acquiring the data from memory through streaming buffer (SB) 225, which interfaces with an IFU/memory execution unit (MEU) interface 230.

If the lookup is for a MS microcode fetch, the data read out of instruction cache 220 is steered to MS 270. The normal macro-instruction path, e.g., length decode and steering, does not see the data. If instead the lookup is for a macro-instruction code fetch, the data read out of the instruction cache is steered to the above path and MS 270 does not see the data.

In the case of a cache miss, the IFU stalls the pipeline and waits for the data. If the lookup was for a macro-instruction code fetch, the IFU detects the return of data from memory and re-issues the original code fetch into the pipeline. If the lookup was for a MS microcode fetch, the MS request engine is responsible for detecting the return of data from memory and re-injecting the MS microcode fetch request into the IFU pipeline. The MS request engine monitors: (1) cache hit/miss for each granted MS request through the IFU pipeline; and (2) an SB data read signal, the MS request engine holds the request that misses in the instruction cache and resends it to the IFU through the same path that it was sent last time such that IFU stalls.

Note that iTLB 210 may be bypassed for MS fetch requests due the need for fetching reset microcode and other initialization microcode. As a result, the MS request engine may generate the corresponding physical address. Note that bypass is associated only with MS fetch requests and thus is transient, enabling the IFU to service interleaved MS fetch requests and macro-instruction code fetch requests.

To support a virtualized microcode sequencer, the following capabilities may be present: decoupling uROM data delivery from the MS pipeline; multiplexing IFU pipeline in time to fetch both macro-instruction and MS microcode fetches; and sharing the instruction cache for both macro-instructions and microcode.

In contrast to conventional MS implementations that rely on fixed uROM read latency (as the uROM read operations are tightly designed into the MS pipeline), embodiments may have a variable and longer latency. That is, where there is not a local uROM, such as where microcode comes from RAM external to the core, the latency can be much higher. Embodiments may provide for logic within the MS pipeline to accommodate the situation where micro-ops are delivered to the pipeline with a variable and long latency.

This logic may implement various operations to enable the latency. First, a microcode instruction pointer (UIP) is recycled until microcode data is delivered to the MS pipeline. This uop recycling mechanism may handle IQ thread allocation and uop queue allocation algorithm and handle the interaction between MS uROM read redirection and micro-operation execution. To this end, a uop valid mechanism may control uops to appear invalid to subsequent pipeline stages until the actual uop data is delivered to the MS pipeline. Still further, the logic may initiate multiple IFU requests to assemble one uROM line to be delivered into the MS pipeline.

Sharing the IFU pipeline for both macro-instruction and microcode fetch can be realized in part by implementing the front end selector or multiplexer to select between the LIP (for macro-instructions) and the MS request's physical address for the next cache lookup. Then, after the cache lookup, steering logic 250 may, after cache lookup steer microcode data to MS 270. Macro-instruction code data is steered to the normal macro-instruction path, e.g., instruction length decoder and instruction steering vector generator. ITLB lookups for MS requests may be bypassed while keeping instruction cache tag lookup valid. A physical address can be used to access microcode RAM space. To further enable multiplexing of the two types of instruction information, the IFU pipeline may service MS requests while the IFU is either in a “sleep” mode or in a “stalled” mode. These modes are preserved while servicing MS requests so that when the MS request is completed, the remainder of the IFU would still think it is either in “sleep” mode (e.g., immediately after hardware reset) or in “stalled” mode. In addition, the IFU may provide for nested stage l stalls. In this way, nested macro-instruction iTLB miss and microcode instruction cache/streaming buffer (IC/SB) miss, nested macro-instruction iTLB fault and microcode IC/SB miss, and macro-instruction uncacheable (UC) memory type fetch and microcode IC/SB miss can occur to bring in service microcode flow to handle iTLB miss/fault/UC fetch. Here, the MS request engine determines such case and makes the SB available for fetching service microcode. Still further, the streaming buffer may be made available for fetching microcode from memory when macro-instruction code fetch is UC and splits across two cache lines, in which case both SB entries are occupied and are released by the microcode service flow. Embodiments may further re-order the arrival time of tag and data when the streaming buffer fills the instruction cache to ensure that concurrent cache lookup will get the correct data for a hit when victim cache (VC) 215 is disabled. Finally, the MS may issue an IFU request only after the machine becomes quiescent, e.g., when the pipeline is drained, the IFU stalled for macro-instruction fetch, and so forth.

To decouple uROM data delivery from the MS pipeline, a uROM image physical base register may specify the offset of the base of uROM image in physical address space. This register may be stored in a fuse block and downloaded to the core during reset. Note that this register may provide for an address space translation from 14-bit uop instruction pointer (UIP) space to 46-bit physical address space. In one embodiment, each uROM line may store 40-bytes worth of data. To ease the address space translation, each uROM line may occupy one 64-byte cache line. Therefore the address space translation enables making the 14-bit UIP as a 64-byte cache line pointer.

Various states may be incorporated in a request engine of a microcode sequencer to decouple uROM data delivery from the microcode sequencer. A first indicator, referred to as Waiting_uROM_Line, may be used to indicate if the MS pipeline is waiting for data, i.e., a uROM line. If a MS fetch request hits in the instruction cache, it takes a few cycles for the MS request engine to receive the data and then deliver the data to the pipeline. If the MS fetch request misses the instruction cache, it can take a variable number of cycles (e.g., much greater than 2) for the MS request engine to receive the data. This wait state can be denoted by this first indicator. This state may be cleared once the MS request engine delivers the received microcode line to the MS pipeline. In various embodiments, the MS request engine does not make another IFU fetch request until the microcode line for the previous request is received and delivered to the MS pipeline. This first indicator is thus used to indicate that there is an outstanding uROM fetch.

A second indicator, referred to as Wait Valid, may be used to indicate whether the first indicator is valid. That is, it may take many cycles for a uROM line to be delivered to the MS pipeline, as explained above. Due to the fact that uop execution and thread selection occur in parallel with uROM line fetching, it is possible that the uROM line being fetched becomes invalid due to branches, events, and thread selection changes before the line is received. Accordingly, this second indicator may track whether any uROM line invalidation condition occurs while the uROM line is being fetched. If this second indicator indicates the uROM line is invalid when it is received, the corresponding line may be dropped or marked as invalid as it is delivered to the MS pipeline.

In one embodiment, a MS request engine may conceptually be considered to contain two finite state machines (FSM's), one interfacing to the MS pipeline itself (and its state machine) and the other of which interfaces to the IFU pipeline (and its state machine).

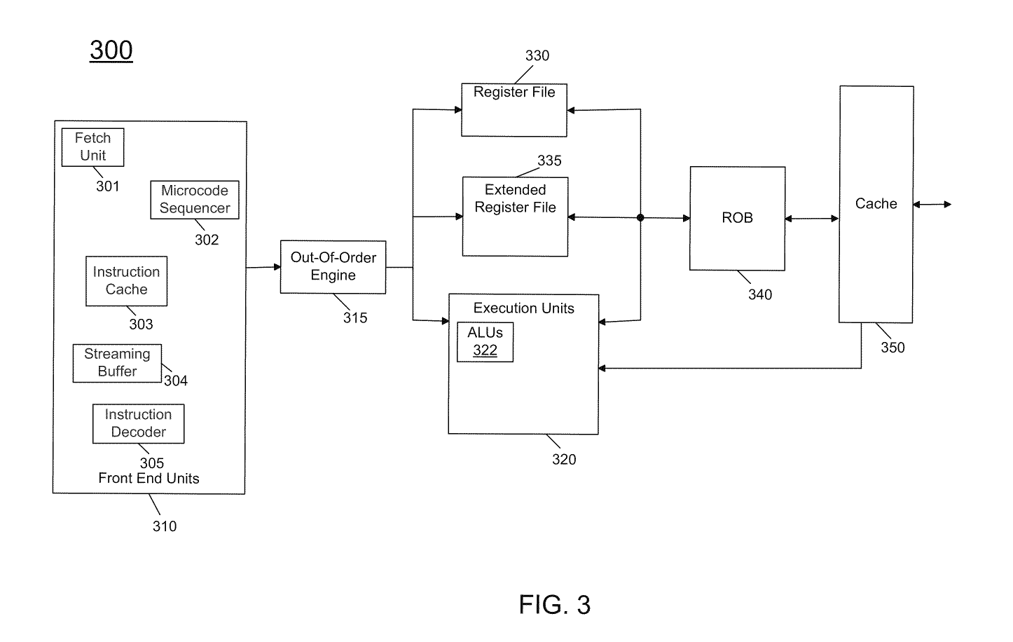

Embodiments can be implemented in many different systems. For example, embodiments can be realized in a processor such as a multicore processor. Referring now to FIG. 3, shown is a block diagram of a processor core in accordance with one embodiment of the present invention. As shown in FIG. 3, processor core 300 may be a multi-stage pipelined out-of-order processor. Processor core 300 is shown with a relatively simplified view in FIG. 3 to illustrate interconnection in accordance with an embodiment of the present invention between an IFU and other portions of a processor pipeline.

As shown in FIG. 3, core 300 includes front end units 310, which may be used to perform instruction fetch and to prepare them for use later in the processor. For example, front end units 310 may include a fetch unit 301, a microcode sequencer 302, an instruction cache 303 that can store both macro-instructions and uops, a streaming buffer 304, and an instruction decoder 305. Fetch unit 301 may fetch macro-instructions, e.g., from memory or instruction cache 303, and feed them to instruction decoder 305 to decode them into primitives, i.e., micro-operations for execution by the processor. In turn, microcode sequencer 302 may interface with the various front end structures to initiate and handle microcode fetches from wherever in a system microcode is stored when the instruction decoder does not decode a given instruction. Streaming buffer 304 may be used to interface with a memory hierarchy to enable the fetch of instructions (including microcode flows) that miss in instruction cache 303. Understand that FIG. 3 is shown at a relatively high level to describe the interaction between components used in performing microcode fetch.

Coupled between front end units 310 and execution units 320 is an out-of-order (OOO) engine 315 that may be used to receive the micro-instructions and prepare them for execution. More specifically OOO engine 315 may include various buffers to re-order micro-instruction flow and allocate various resources needed for execution, as well as to provide renaming of logical registers onto storage locations within various register files such as register file 330 and extended register file 335. Register file 330 may include separate register files for integer and floating point operations. Extended register file 335 may provide storage for vector-sized units, e.g., 256 or 512 bits per register.

Various resources may be present in execution units 320, including, for example, various integer, floating point, and single instruction multiple data (SIMD) logic units, among other specialized hardware. For example, such execution units may include one or more arithmetic logic units (ALUs) 322. Results may be provided to retirement logic, namely a reorder buffer (ROB) 340. More specifically, ROB 340 may include various arrays and logic to receive information associated with instructions that are executed. This information is then examined by ROB 340 to determine whether the instructions can be validly retired and result data committed to the architectural state of the processor, or whether one or more exceptions occurred that prevent a proper retirement of the instructions. Of course, ROB 340 may handle other operations associated with retirement.

As shown in FIG. 3, ROB 340 is coupled to a cache 350 which, in one embodiment may be a low level cache (e.g., an L1 cache). Also, execution units 320 can be directly coupled to cache 350. From cache 350, data communication may occur with higher level caches, system memory and so forth. While shown with this high level in the embodiment of FIG. 3, understand the scope of the present invention is not limited in this regard.

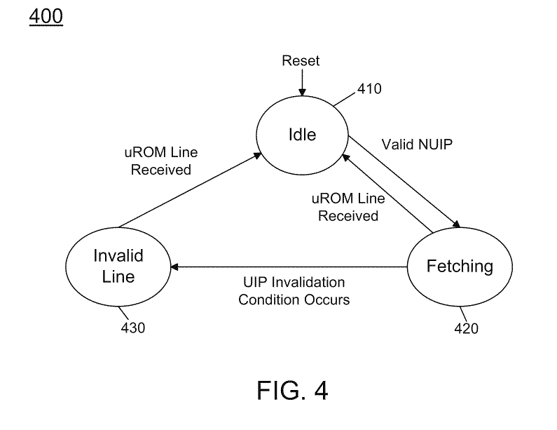

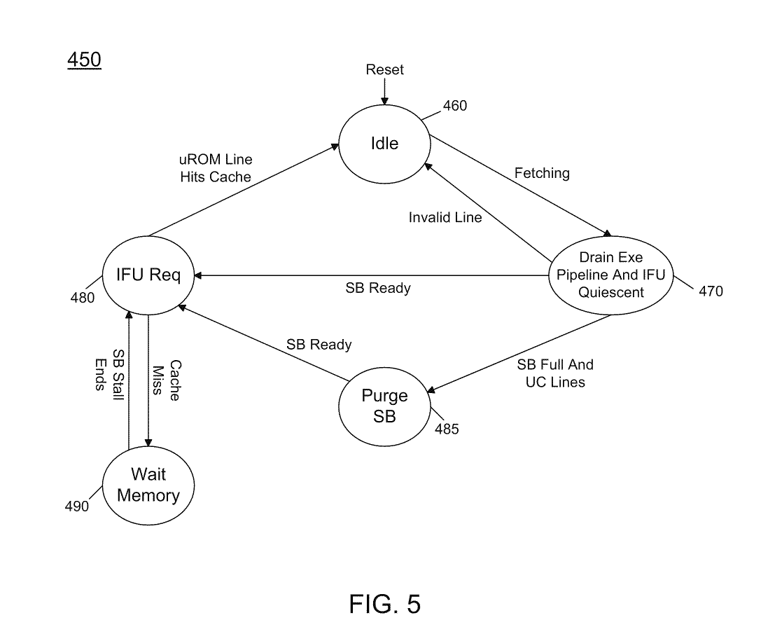

FIG. 4 is a block diagram of a state machine in accordance with one embodiment of the present invention, and FIG. 5 is a block diagram of a state machine in accordance with another embodiment of the present invention. As shown in FIG. 4, a valid next UIP (NUIP) received from a front end multiplexer of the MS triggers the first FSM to enter the Fetching state (block 420) from an idle state (block 410). Subsequently, this first FSM entering the Fetching state triggers the second FSM to move from an idle state 460 to enter a state that waits for the out-of-order (OOO)/execution (EXE) pipeline to be drained and for the IFU to become quiescent (block 470).

Note that if branches or events are detected or thread selection flips, the first FSM will leave Fetching state and enter the Invalid Line state (block 430). If the second FSM is in the Wait state, e.g., waiting for the pipeline to drain when this transition happens, this FSM returns to the idle state (block 460) and no IFU request is made. However, if the second FSM has already transitioned out of the wait state (e.g., waiting for pipeline drain state) when this transition happens, it will complete its IFU requests (block 450).

As shown in FIG. 4, state machine 400 may be part of a MS engine and may be used to handle interaction between requests for microcode located outside of the MS and the MS pipeline itself. As seen, three states are present, namely an idle state 410, a fetching state 420, and an invalid state 430. Control passes from idle state 410 to fetching state 420 on a valid NUIP, storage of which is in memory external to the core. The idle state is returned to if the requested line is received without an invalidation condition occurring. If such a condition occurs, control passes to state 430, where a receive line may be marked as invalid before control passes back to idle state 410.

With regard to state machine 450, which is a state machine that interfaces the MS request engine and the IFU pipeline, an idle state 460 is exited when a fetching state occurs, which causes a state 470 to be entered to cause the IFU to become quiescent and an execution pipeline to be drained. If the streaming buffer is ready, control passes to an IFU request state 480, where the request can be made of the IFU. If the line is present in the cache, it is returned to the MS request engine and control passes back to the idle state. Otherwise on a cache miss, a wait memory state 490 occurs. Note that if the streaming buffer is full and uncacheable lines are present, a purge streaming buffer state 485 is entered from state 470.

Once the full uROM line is received in the MS, the second FSM delivers the line to the first FSM, which will then return to the idle state (block 410). Note that this line will be marked as invalid as it is delivered to the MS pipeline (and thus will not be executed) if the first FSM is in the Invalid Line state when it receives the line.

Some processor implementations may include an IFU and front end (FE) pipeline designed to fetch macro-instruction bytes only. To enable embodiments to be adapted to such a design (and allow storage of received microcode in the instruction cache), the IFU may be multiplexed in time, as discussed above. In this way, the IFU can service fetch requests from both the normal macro-instruction state machines and the microcode sequencer. As such, microcode data may be present within RAM, cache hierarchy, IFU, and MS. To this end, the logic of FIG. 2 may be incorporated within the pipeline and control to enable sharing of the instruction cache between complex or macro-instructions (e.g., complex instruction set computing (CISC) instructions) and uops.

The IFU may handle various stall conditions when fetching macro-instruction instructions. Even though these conditions may not result in actual data-path pipeline stall due to simultaneous multithreading (SMT), a thread-specific fetching engine may be implemented to handle these conditions. In one embodiment, these stall conditions are partitioned into two groups (GRP1 and GRP2) as follows.

GRP1 stall conditions are conditions that need microcode assists, and may include ITLB fault, ITLB miss, and UC fetch. GRP2 stall conditions may be conditions that can be resolved purely by hardware such as a miss in the instruction cache, instruction victim cache and instruction streaming buffer, a hit in the streaming buffer with data not ready (SBstall), a miss to a locked instruction cache set, or where the stream buffer not ready for a fetch request.

In one embodiment, the “IFU quiescent” portion of “drain exe pipeline & IFU quiescent” (state 420) of the second FSM of FIG. 5 may implement the following algorithm, in one embodiment:

check_IFU_status:

if (IFU_iqfull_stalled OR IFU_sleep OR IFU_GRP2_stalled)

IFU_quiescent;
go to check_IFU_status_exit;

else if (IFU_busy OR IFU_GRP1_stalled)

wait;
go to check_IFU_status;

check_IFU_status_exit.

Macro-instruction code fetch cache misses are sent to a stall address, stall handler, and SB. The stall address and stall handler are designed to control the pipeline, while the SB is designed to fetch macro-instruction code from memory on a cache miss. For microcode fetch, cache misses are gated from going to the stall address and stall handler but continue to go to the SB. Therefore the SB is used to fetch code from memory for both macro-instruction code and microcode. In addition, microcode fetch cache misses may also be sent to the microcode requester and the SB will also inform the microcode requester when data from memory is ready. Accordingly, the microcode requester may re-issue the request through a front end multiplexer of the MS (e.g., multiplexer 205 of FIG. 2) upon receiving a data ready signal from the SB.

A UC code fetch that splits across cache lines gives rise to a boundary condition in which the SB provides two entries that can hold two cache lines. To obtain all bytes of an instruction in this situation, two cache lines are to be read and thus all SB resources are consumed. On the other hand, before the entire UC fetch sequence can be completed so that SB entries that hold UC code cache lines can be released, a microcode fetch is performed. Therefore, the “SB full & UC line” state of the second FSM may be implemented to release SB resources for microcode fetch (block 485) after UC code fetch is done and consumed but before the normal UC fetch sequence can be completed to release such resources.

Microcode sequencer virtualization in accordance with an embodiment of the present invention thus allows “microcode” to be generated (even at run time) and stored in the architecturally addressable RAM space other than uROM. The virtualized microcode sequencer enables a processor to fetch and sequence both existing uROM microcode as well as microcode flows generated at run time. In certain embodiments, an IFU can be used to fetch “microcode” stored in the architecturally addressable space into the machine and to cache them into the instruction cache. Using an embodiment of the present invention, microcode can be generated post-silicon, which provides flexibilities to extend a silicon feature set post-silicon. Further by enabling more realizable microcode update, a new revenue source for a processor manufacturer can be realized. Furthermore, flexible microcode strategies enable performance/cost/power/complexity trade-off, and can further provide new ways to work around silicon issues. In one embodiment, thread selection may be based on IQ (instruction queue) emptiness, IDQ (uop queue/buffer) fullness (pre-allocation), and MS state (idle/stall).

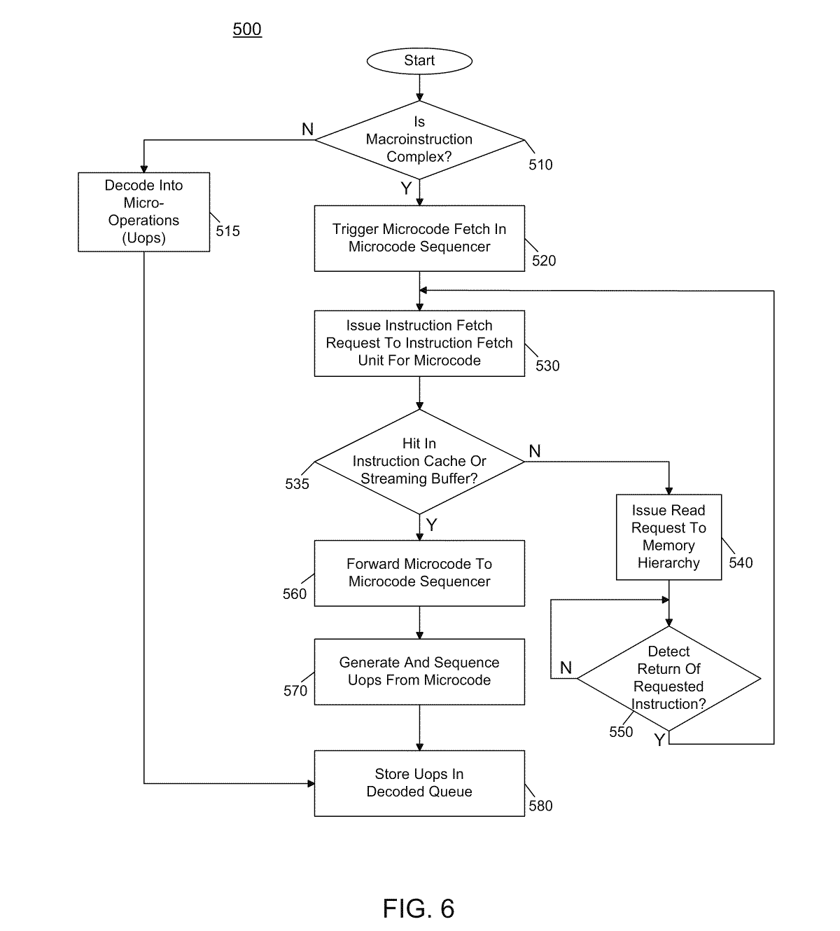

Referring now to FIG. 6, shown is a flow diagram of a method for performing microcode sequencing operations in accordance with one embodiment of the present invention. As shown in FIG. 6, method 500 may begin by determining whether a given macro-instruction is complex (diamond 510). For example, as discussed above, a macro-instruction may be considered complex when more than a minimal number of uops are used to perform the operations of the instruction. If the macro-instruction is not considered to be complex, an instruction decoder may decode the macro-instruction into one or more uops (block 515). Then control passes to block 580, where the uops may be stored in a decoded instruction queue, from which they may be accessed, e.g., by an out-of-order engine that reorders the uops for execution in one or more execution units of the processor.

If instead it is determined that the macro-instruction is complex, control instead passes from diamond 510 to block 520. There a microcode fetch may be triggered in a microcode sequencer. That is, if the determination is made that the macro-instruction is complex, the instruction decoder may send a signal and the corresponding macro-instruction to the microcode sequencer for implementing fetch and sequencing operations. Microcode fetch may be triggered by issuing an instruction fetch request for the microcode (block 530). This request may be sent from the microcode sequencer in the form of a next uop instruction pointer, which after being translated into a physical address is sent to a front end of the instruction fetch unit.

As discussed above, time multiplexing may occur between this instruction request and requests coming from other paths to the IFU such as branch predictors or so forth. When the multiplexer or other selector of the instruction fetch unit provides the uop instruction pointer in the form of physical address to storage structures of the IFU including an instruction cache and a streaming buffer, it may be determined whether a hit occurs (diamond 535). If not, the IFU issues a read request to the memory hierarchy to obtain the requested microcode. That is, because the micro sequencer does not include an on-board uROM, a read request is issued to the addressable memory space (block 540). At various intervals, the microcode sequencer may detect the return of the requested instruction (diamond 550). This detection may be implemented using various mechanisms of the microcode sequencer. For example, the IFU may allow one outstanding instruction cache miss at a time. The IFU stalls when an instruction cache miss occurs and waits for data from the SB. The SB informs a stall FSM to reissue the request in a normal case. When a virtualized microcode sequencer in accordance with an embodiment of the present invention is actuated, the IFU stall FSM will not change state. So the MS requester hijacks the SB signal on data ready, when the return is detected, and control passes back to block 530, discussed above. This time, a hit will occur in at least the streaming buffer. Accordingly, control passes to block 560, where the desired microcode is received in the microcode sequencer. Accordingly, the microcode sequencer may generate and sequence from the received microcode a set of uops that correspond to the macro-instruction (block 570). Control then again passes to block 580, for storage of the uops in the decoded queue, where they can be provided to the pipeline. While shown with this particular implementation in the embodiment of FIG. 6, understand the scope of the present invention is not limited in this regard.

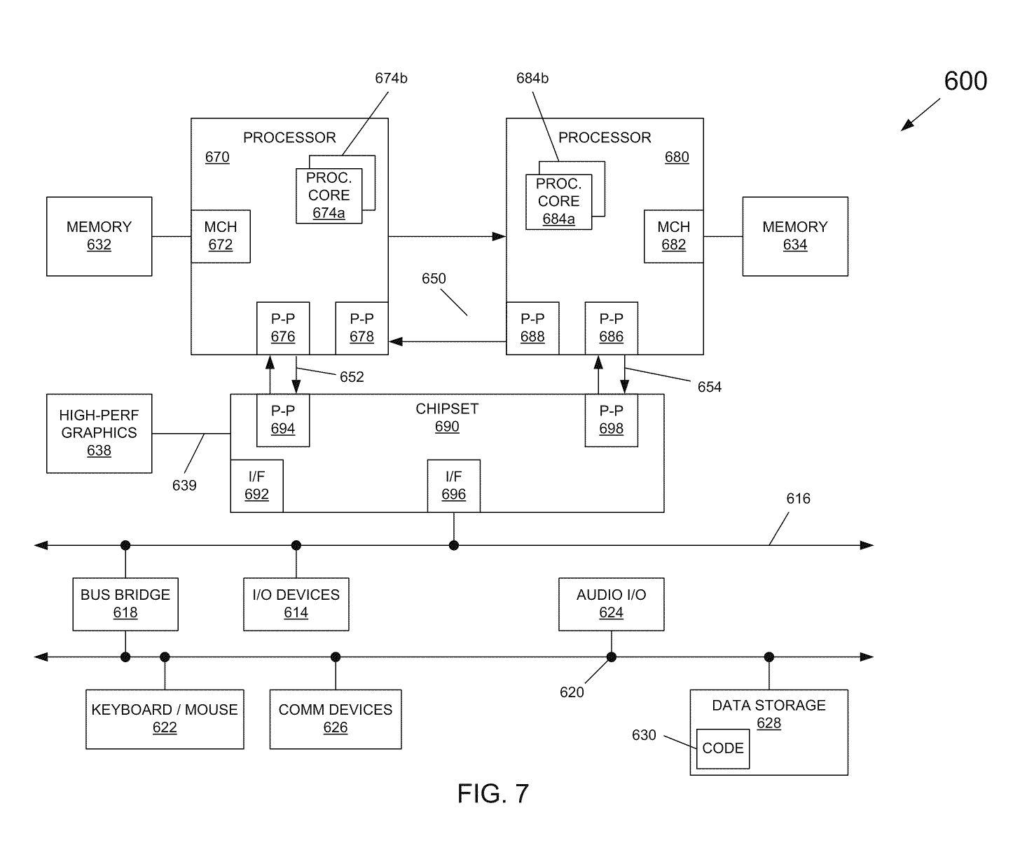

Embodiments may be implemented in many different system types. Referring now to FIG. 7, shown is a block diagram of a system in accordance with an embodiment of the present invention. As shown in FIG. 7, multiprocessor system 600 is a point-to-point interconnect system, and includes a first processor 670 and a second processor 680 coupled via a point-to-point interconnect 650. As shown in FIG. 7, each of processors 670 and 680 may be multicore processors, including first and second processor cores (i.e., processor cores 674a and 674b and processor cores 684a and 684b), although potentially many more cores may be present in the processors. These cores may, in some embodiments, not include a uROM and instead using a microcode sequencer in accordance with an embodiment of the present invention, access microcode from the addressable memory hierarchy of the system.

Still referring to FIG. 7, first processor 670 further includes a memory controller hub (MCH) 672 and point-to-point (P-P) interfaces 676 and 678. Similarly, second processor 680 includes a MCH 682 and P-P interfaces 686 and 688. As shown in FIG. 7, MCH's 672 and 682 couple the processors to respective memories, namely a memory 632 and a memory 634, which may be portions of main memory (e.g., a dynamic random access memory (DRAM)) locally attached to the respective processors. First processor 670 and second processor 680 may be coupled to a chipset 690 via P-P interconnects 652 and 654, respectively. As shown in FIG. 7, chipset 690 includes P-P interfaces 694 and 698.

Furthermore, chipset 690 includes an interface 692 to couple chipset 690 with a high performance graphics engine 638, by a P-P interconnect 639. In turn, chipset 690 may be coupled to a first bus 616 via an interface 696. As shown in FIG. 7, various input/output (I/O) devices 614 may be coupled to first bus 616, along with a bus bridge 618 which couples first bus 616 to a second bus 620. Various devices may be coupled to second bus 620 including, for example, a keyboard/mouse 622, communication devices 626 and a data storage unit 628 such as a disk drive or other mass storage device which may include code 630, in one embodiment. Further, an audio I/O 624 may be coupled to second bus 620.

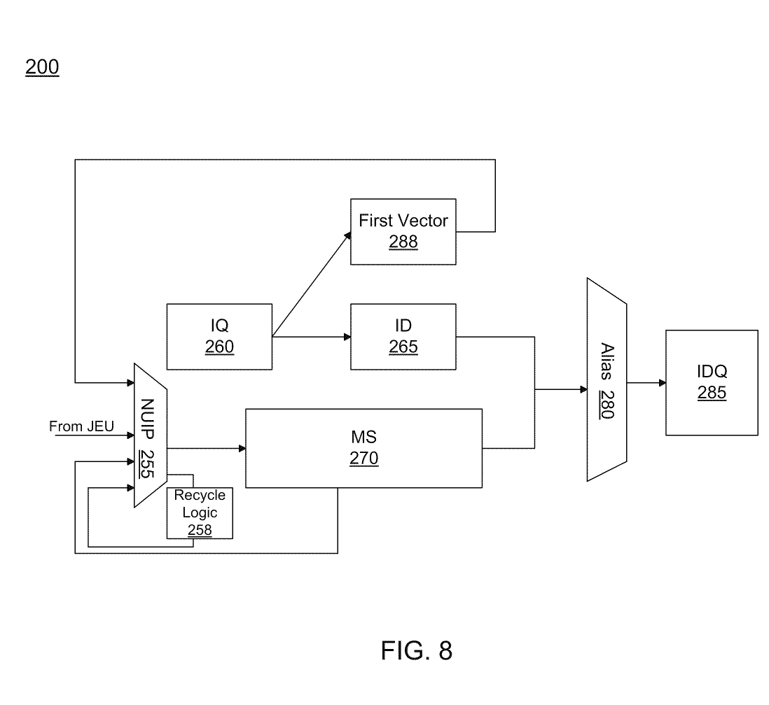

Referring now to FIG. 8, shown is a block diagram of interaction between MS NUIP generation logic and various components of an IFU. In one embodiment, various inputs may be provided to the next UIP generation logic that is coupled to a front end of the MS. As shown in FIG. 8, next UIP generation logic 255 may be coupled to MS 270. However note that in various embodiments, this logic may actually be incorporated in a front end of the MS itself. Logic 255 is coupled to receive a first vector 288, information from a jump execution unit (JEU), as well as address information from MS 270 and a recycle logic 258. The remaining structures shown in FIG. 8 may be as above discussed with regard to FIG. 2.

When decoder 265 detects a CISC instruction, it provides the first number of uops (e.g., 4) to decoded queue 285, and the remainder will be delivered by the MS. A first vector 288 is the MS entry point UIP generated for the MS to read the uops immediately following the first 4 uops delivered by instruction decoder 265. Subsequently, NUIP logic 255 selects one UIP from UIPs generated by the JEU, MS branch execution, or recycle logic 258. Note that recycle logic 258 may tolerate cache miss and stalls in the IFU when uops are fetched from memory.

Mechanisms may enable a front end restart to work with or without a victim cache (VC), which enables maintaining an inclusive property. Each instruction cache line may include a tag with a bit to differentiate a macro-instruction line and a microcode line. In general, the logic may operate to detect a CISC instruction X, and determine the UIP. Then the cache lines that contain X can be identified, which may be 1 or 2 cache lines that could be in the instruction cache or VC. The IFU is caused to be quiescent and the pipeline is drained. If both lines containing X are in VC, the MS may resume, described further below. If instead, one line is in the VC and one line is in the instruction cache, the line in the VC is read out and then the VC is flushed. Next lines in the instruction cache containing X are evicted into the VC and the line from the instruction cache is read out, if it exists, is moved into the VC. Thereafter, the MS resumes, and the IFU fetches both macro-instructions and microcode. When a new line is to be placed into the instruction cache, if it is a macro-instruction line, the replaced macro-instruction line is evicted into the VC, whereas a replaced microcode line is simply dropped. Note that without a VC, the MS request engine resets the front end restart FSM to start over if the front end restart misses in the cache.

Embodiments may be implemented in code and may be stored on a storage medium having stored thereon instructions which can be used to program a system to perform the instructions. The storage medium may include, but is not limited to, any type of disk including floppy disks, optical disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. An apparatus comprising:
an instruction cache to store macro-instructions and micro-instructions (uops);
a streaming buffer to store incoming macro-instructions and uops received from a memory hierarchy;
a first microcode sequencer interface to pass uops from the instruction cache and the streaming buffer to a microcode sequencer, the microcode sequencer not including a microcode read only memory (uROM); and
a second microcode sequencer interface to pass a next uop instruction pointer to the instruction cache and the streaming buffer from the microcode sequencer.

2. The apparatus of claim 1, wherein the apparatus comprises a processor including a plurality of cores and uncore logic.

3. The apparatus of claim 2, wherein the uncore logic includes a read only memory to store microcode for the plurality of cores.

4. The apparatus of claim 3, wherein the read only memory comprises an architecturally addressable address space.

5. The apparatus of claim 2, wherein microcode for the plurality of cores is stored in the uncore logic.

6. The apparatus of claim 2, further comprising a binary translated microcode block stored in a memory of a system including the processor.

7. The apparatus of claim 2, further comprising a statically compiled microcode block stored in a memory of a system including the processor.

8. The apparatus of claim 1, further comprising a selector to receive a first instruction pointer from a branch prediction unit and the next uop instruction pointer from the microcode sequencer, wherein the selector is to provide the next uop instruction pointer to the instruction cache and the streaming buffer after an execution pipeline has been drained.

9. A method comprising:
sending a request for microcode corresponding to a macro-instruction from a microcode sequencer of a processor to an instruction fetch unit coupled to the microcode sequencer, wherein the microcode sequencer does not include a microcode storage; and
issuing a read request to an addressable memory space of a system including the processor if the microcode request does not hit in an instruction cache or a streaming buffer of the instruction fetch unit, wherein the instruction cache is to store both micro-instructions and micro-operations (uops).

10. The method of claim 9, further comprising detecting a return of the macro-instruction in the microcode sequencer and re-issuing the request to the instruction fetch unit.

11. The method of claim 10, further comprising receiving the microcode in the microcode sequencer from the instruction fetch unit after re-issuing the request.

12. The method of claim 11, further comprising generating and sequencing a set of uops that correspond to the macro-instruction from the received microcode.

13. The method of claim 12, further comprising storing the set of uops in a decoded queue and providing the set of uops to an out-of-order engine of the processor.

14. The method of claim 9, further comprising receiving the microcode in the streaming buffer responsive to the read request from a volatile storage of the system, the microcode generated at runtime.

15. A system comprising:
a processor including a plurality of cores and an uncore, the uncore including a microcode read only memory (uROM) to store microcode to be executed in the plurality of cores, wherein each of the cores includes a microcode sequencer to sequence a plurality of micro-instructions (uops) of microcode of the uROM, the sequenced uops corresponding to a macro-instruction to be executed in an execution unit of the corresponding core, wherein the cores do not include a uROM; and
a dynamic random access memory (DRAM) coupled to the processor.

16. The system of claim 15, wherein each of the plurality of cores includes an instruction cache to store macro-instructions and uops, a streaming buffer to store incoming macro-instructions and uops received from a memory hierarchy, a first microcode sequencer interface to pass uops from the instruction cache or the streaming buffer to the microcode sequencer and a second microcode sequencer interface to pass a next uop instruction pointer to the instruction cache and the streaming buffer from the microcode sequencer.

17. The system of claim 15, further comprising a selector to provide a next uop instruction pointer to the microcode sequencer, the next uop instruction pointer selected from address information received from the microcode sequencer, a first vector storage, a recycle logic, and a jump unit.

18. The system of claim 15, wherein the instruction cache includes a plurality of entries each to store one or more uops or at least a portion of a macro-instruction, each entry further including a state indicator to identify whether the entry includes uop information or macro-instruction information.

19. The system of claim 15, wherein the DRAM is to store a binary translated microcode block generated during runtime of the system.

20. The system of claim 15, wherein the DRAM is to store a statically compiled microcode block.
